(19) United States
(12) Patent Application Publication
(10) Pub. No.: US 2012/0003076 A1
(43) Pub. Date: Jan. 5, 2012

(54) METHOD AND APPARATUS FOR ASSEMBLING ROTATING MACHINES

(76) Inventors: Josef Scott Cummins, Simpsonville, SC (US); Ian David Wilson, Simpsonville, SC (US)

(21) Appl. No.: 12/827,774

(22) Filed: Jun. 30, 2010

(51) Int. Cl. F01D 11/00; B21K 25/00; B23P 15/00

(52) U.S. Cl. 415/113; 29/889.2; 415/173.7

(57) ABSTRACT

A method for assembling a rotating machine includes providing a rotating element including a plurality of rotor wheels. The method also includes positioning the rotating element such that at least a portion of a stationary portion extends at least partially about the rotating element. The method further includes assembling an interstage seal mechanism including coupling at least a portion of a first hook device to the rotating element, and also including coupling at least a portion of a second hook device to the first hook device. The first hook device and the second hook device are radially inboard of at least a portion of the stationary portion.

### BACKGROUND OF THE INVENTION

The embodiments described herein relate generally to rotating machines and, more particularly, to methods and apparatus for assembling turbine engines.

At least some known turbine engines include a plurality of rotating turbine blades or buckets that channel high-temperature fluids, or more specifically, combustion gases through gas turbine engines or steam through steam turbine engines. Known buckets are typically coupled to a wheel portion of a rotor within the turbine engine and cooperate with the rotor to form a turbine section. Moreover, known turbine buckets are typically arranged in axially-successive rows. Many known turbine engines also include a plurality of stationary nozzle segments that channel the fluid flowing through the engine downstream towards the rotating buckets. Each nozzle segment, in conjunction with an associated row of turbine buckets, is usually referred to as a turbine stage and most known turbine engines include a plurality of turbine stages.

Moreover, at least some of the known gas turbine engines also include a plurality of rotating compressor blades that channel air through the gas turbine engine. Known rotating compressor blades are typically coupled to a wheel portion of the rotor and cooperate with the rotor to form a compressor section. Such known compressor blades are typically arranged in axially-successive rows. Many known compressors also include a plurality of stationary stator segments that channel air downstream towards the rotating compressor blades. Each stator segment, in conjunction with an associated row of blades, is usually referred to as a compressor stage and most known turbine engine compressors include a plurality of stages.

Many known turbine nozzle and compressor stator segments extend radially inward from an outer casing portion of each of the turbine and the compressor towards the rotor. As such, an annular flow path is defined between adjacent rows of buckets and blades, respectively. Sealing devices are typically positioned within the annular path to facilitate reducing fluid leakage in the turbine and reducing air leakage in the compressor.

Because many known sealing devices are exposed to high-pressure and/or high-temperature fluids for extended periods of time, such sealing devices are frequently inspected to determine if repairs are necessary. However, inspections generally necessitate extensive disassembly of the turbine engine, including at least partial removal of adjacent rows of turbine buckets or compressor blades. Moreover, many known nozzle and stator segments are fabricated of expensive alloys and cost and weight of such segments increases in proportion to a radial length of the segments.

### BRIEF DESCRIPTION OF THE INVENTION

This Brief Description is provided to introduce a selection of concepts in a simplified form that are further described below in the Detailed Description. This Brief Description is not intended to identify key features or essential features of the claimed subject matter, nor is it intended to be used as an aid in determining the scope of the claimed subject matter.

In one aspect, a method for assembling a rotating machine is provided. The method includes providing a rotating element including a plurality of rotor wheels. The method also includes positioning the rotating element such that at least a portion of a stationary portion extends at least partially about the rotating element. The method further includes assembling an interstage seal mechanism including coupling at least a portion of a first hook device to the rotating element, and also including coupling at least a portion of a second hook device to the first hook device. The first hook device and the second hook device are radially inboard of at least a portion of the stationary portion.

In another aspect, an interstage seal mechanism for a rotating machine is provided. The rotating machine has a rotating element and a stationary portion and the rotating element has a plurality of rotor wheels. The interstage seal mechanism includes a bridge portion rotatably coupled to at least one of the rotor wheels. The bridge portion extends axially between the rotor wheels. The bridge portion includes a first hook device. The interstage seal mechanism also includes a ring portion at least partially circumscribing the bridge portion. The ring portion includes a second hook device rotatably coupled to the first hook device.

In another aspect a turbine engine is provided. The turbine engine includes a rotating element that includes a plurality of rotor wheels and a stationary portion that at least partially extends about the rotating element. The turbine engine also includes at least one interstage seal mechanism. The interstage seal mechanism includes a bridge portion rotatably coupled to at least one of the rotor wheels. The bridge portion extends axially between the rotor wheels. The bridge portion includes a first hook device. The interstage seal mechanism also includes a ring portion at least partially circumscribing the bridge portion. The ring portion includes a second hook device rotatably coupled to the first hook device.

### BRIEF DESCRIPTION OF THE DRAWINGS

FIG. 1 is a schematic diagram of an exemplary turbine engine;

FIG. 2 is an enlarged cross-sectional view of a portion of a compressor that may be used with the gas turbine engine shown in FIG. 1 and taken along area 2;

FIG. 3 is an enlarged cross-sectional view of a portion of a turbine that may be used with the gas turbine engine shown in FIG. 1 and taken along area 3;

FIG. 4 is an enlarged cross-sectional view of a portion of an exemplary interstage seal mechanism that may be used with the compressor shown in FIG. 2 and taken along area 4;

FIG. 5 is an enlarged cross-sectional view of a portion of an exemplary interstage seal mechanism that may be used with the turbine shown in FIG. 3 and taken along area 5; and

FIG. 6 is a flow chart illustrating an exemplary method of assembling a portion of the gas turbine engine shown in FIG. 1.

### DETAILED DESCRIPTION OF THE INVENTION

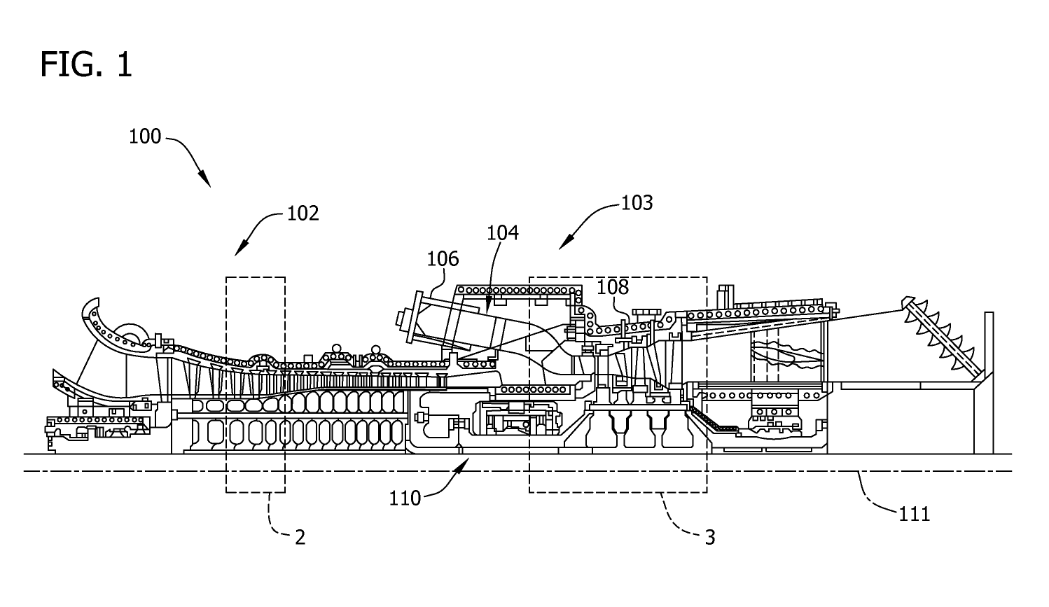

FIG. 1 is a schematic diagram of a rotating machine, i.e., a turbine engine, and more specifically, an exemplary gas turbine engine 100. Engine 100 includes a compressor 102 and a combustor assembly 103 including a plurality of combustors 104 that each includes a fuel nozzle assembly 106. In the exemplary embodiment, engine 100 also includes a turbine 108 and a common compressor/turbine rotor 110 (sometimes referred to as rotor 110). Rotor 110 defines a rotor axial centerline 111. In one embodiment, engine 100 is a MS9001E engine, sometimes referred to as a 9E engine, commercially available from General Electric Company, Schenectady, N.Y.

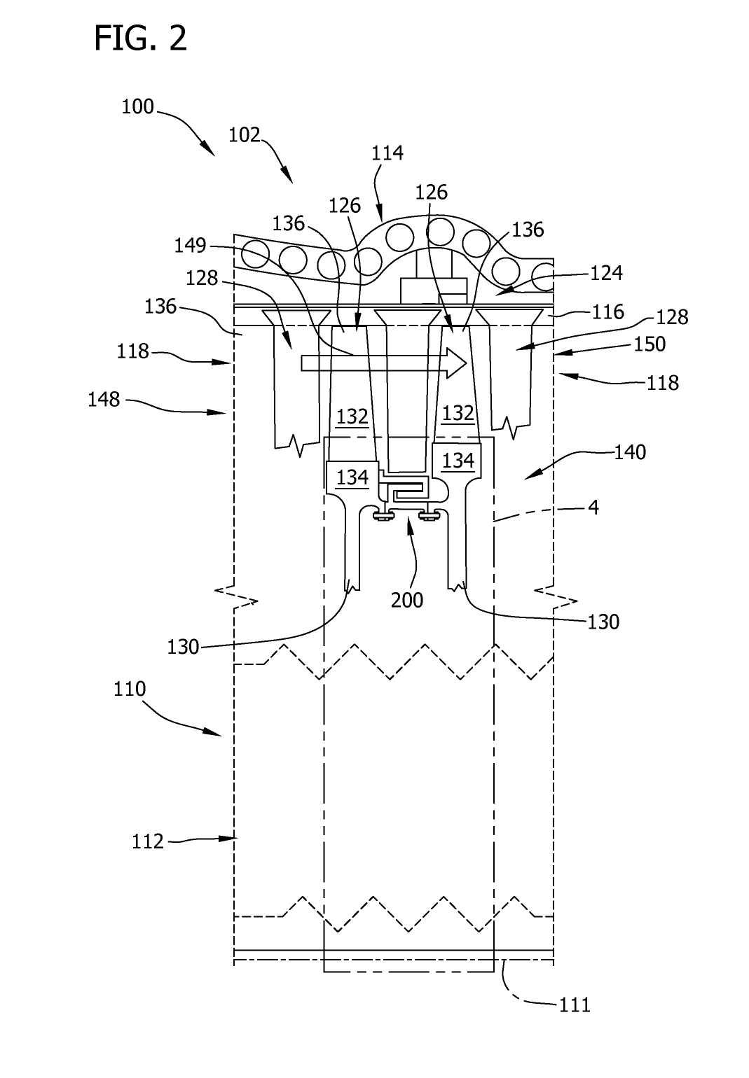

FIG. 2 is an enlarged cross-sectional view of a portion of compressor 102 used with gas turbine engine 100 and taken along area 2 (shown in FIG. 1). Compressor 102 includes a compressor rotor assembly 112 and a stationary portion, or more specifically, a compressor stator assembly 114 that are positioned within a compressor casing 116 that at least partially defines a flow path 118. In the exemplary embodiment, compressor rotor assembly 112 forms a portion of rotor 110. Moreover, in the exemplary embodiment, compressor 102 is oriented substantially symmetrically about rotor axial centerline 111. Also, in the exemplary embodiment, compressor 102 is a portion of gas turbine engine 100. Alternatively, compressor 102 is any rotating, bladed, multi-stage fluid transport apparatus including, but not limited to, a stand-alone fluid compression unit or a fan.

Compressor 102 includes a plurality of stages 124, wherein each stage 124 includes a row of circumferentially-spaced rotor blade assemblies 126 and a row of stator blade assemblies 128, sometimes referred to as stator vanes. In the exemplary embodiment, rotor blade assemblies 126 are coupled to a wheel portion, or more specifically, a compressor rotor disc or wheel 130 via an attachment mechanism 134 such that each blade assembly 126 extends radially outwardly from compressor rotor wheel 130. Also, in the exemplary embodiment, a plurality of compressor rotor wheels 130 and a plurality of blade attachment mechanisms 134 at least partially define a generally convergent compressor hub 140. Moreover, each assembly 126 includes a rotor blade airfoil portion 132 that extends radially outward from blade attachment mechanism 134 to a rotor blade tip portion 136. Compressor stages 124 cooperate with a motive or working fluid including, but not limited to, air, such that the motive fluid is compressed in succeeding stages 124. An interstage seal mechanism 200 is coupled to each rotor wheel 130 and/or blade attachment mechanism 134.

In operation, compressor 102 is rotated by turbine 108 via rotor 110. Fluid collected from a low pressure or compressor upstream region 148 via stages 124 is channeled by rotor blade airfoil portions 132 towards stator blade assemblies 128. The fluid is compressed and a pressure of the fluid is increased as the fluid is channeled through flow path 118 as indicated by a flow arrow 149. More specifically, the fluid continues to flow through subsequent stages 124 with flow path 118 generally narrowing with successive stages 124 to facilitate compressing and pressurizing the fluid as it is channeled through flow path 118. Compressed and pressurized fluid is subsequently channeled into a high pressure or compressor downstream region 150 for use within turbine engine 100.

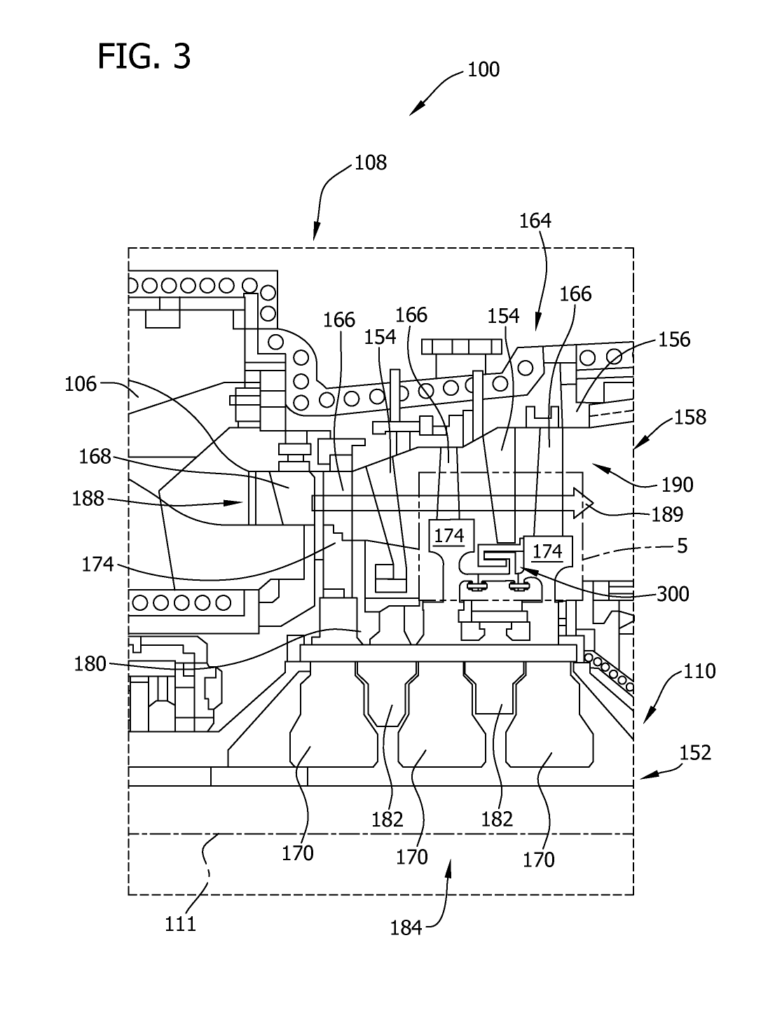

FIG. 3 is an enlarged cross-sectional view of a portion of turbine 108 that may be used with gas turbine engine 100 and taken along area 3 (shown in FIG. 1). Turbine 108 includes a turbine rotor assembly 152. Turbine 108 also includes a plurality of stationary blades, or turbine diaphragm assemblies 154 that are positioned within a turbine casing 156 that at least partially defines a flow path 158. In the exemplary embodiment, turbine rotor assembly 152 forms a portion of rotor 110. Moreover, in the exemplary embodiment, turbine 108 is oriented substantially symmetrically about rotor axial centerline 111. Also, in the exemplary embodiment, turbine 108 forms a portion of gas turbine engine 100. Alternatively, turbine 108 is any rotating, bladed, multi-stage energy conversion apparatus including, but not limited to, a steam turbine.

Turbine 108 includes a plurality of stages 164, wherein each stage 164 includes a row of circumferentially-spaced rotor blades, or bucket assemblies 166 and a row of diaphragm assemblies 154, or a nozzle assembly 168. In the exemplary embodiment, turbine 108 includes three successive stages 164. Alternatively, turbine 108 includes any number of stages 164 that enables turbine engine 100 to operate as described herein. Also, in the exemplary embodiment, bucket assemblies 166 are coupled to a turbine rotor wheel 170 via a bucket attachment mechanism 174, such that each bucket assembly 166 extends radially outwardly from turbine rotor wheel 170. A plurality of turbine rotor wheels 170 and a plurality of bucket attachment mechanisms 174 at least partially define a generally divergent turbine hub 180. In the exemplary embodiment, turbine 108 includes three turbine rotor wheels 170 with a spacer 182 between each wheel 170 for a total of five turbine rotor discs 184. Turbine stages 164 cooperate with a motive or working fluid including, but not limited to, combustion gases, steam, and compressed air such that the motive fluid is expanded in succeeding stages 164. An interstage seal mechanism 300 is coupled to each rotor wheel 170 and/or blade attachment mechanism 174.

In operation, in the exemplary embodiment, turbine 108 receives high pressure combustion gases generated by fuel nozzle assembly 106. Combustion gases collected from a high pressure or turbine upstream region 188 via nozzle assembly 168 are channeled by bucket assemblies 166 towards diaphragm assemblies 154. As the combustion gases are channeled through flow path 158, as indicated by a flow arrow 189, the combustion gases are at least partially decompressed and a pressure of the combustion gases is at least partially decreased. More specifically, the combustion gases continue to flow through subsequent stages 164 with flow path 158 generally expand within each successive stage 164 to facilitate decompressing and depressurizing the combustion gases as the gases are channeled through flow path 158. Decompressed and depressurized combustion gases are subsequently discharged into a low pressure region 190 for either further use within turbine engine 100 or exhausted from turbine engine 100.

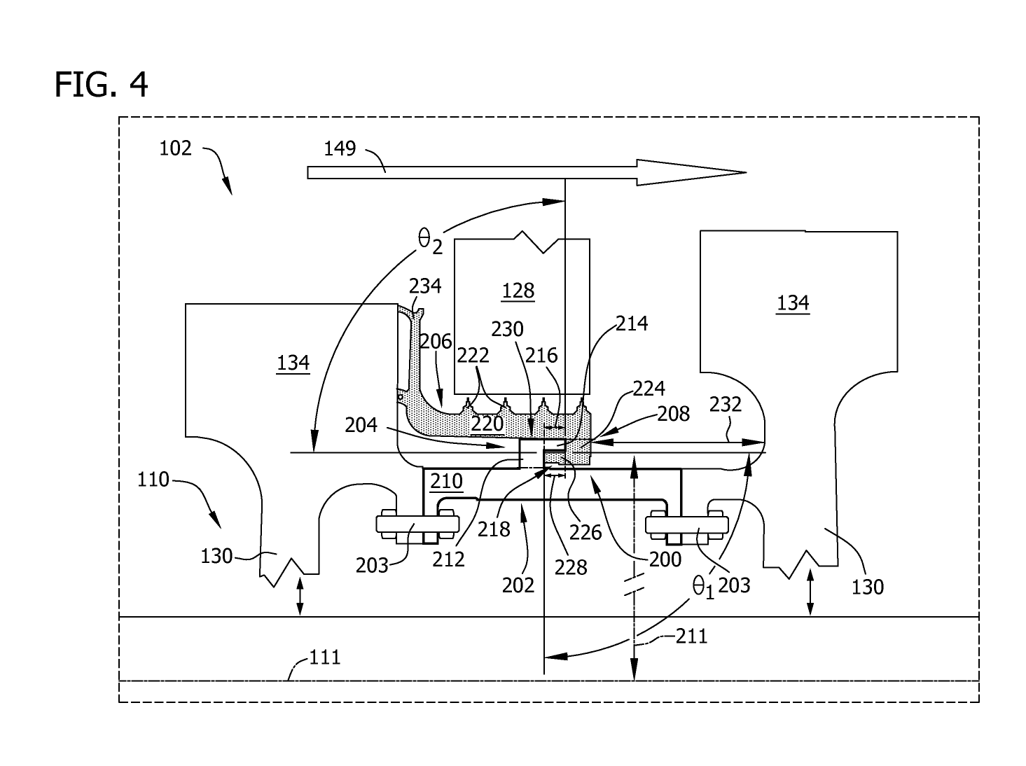

FIG. 4 is an enlarged cross-sectional view of a portion of an exemplary interstage seal mechanism 200 that may be used with compressor 102 taken along area 4 (shown in FIG. 2). In the exemplary embodiment, interstage seal mechanism 200 fully and continuously circumscribes rotor 110. For clarity, rotor blade airfoil portions 132 (shown in FIG. 2) are not illustrated in FIG. 4. In the exemplary embodiment, interstage seal mechanism 200 includes a bridge portion 202 that extends axially between a pair of adjacent compressor rotor wheels 130. Bridge portion 202 is rotatably coupled to at least one compressor rotor wheel 130. Specifically, in the exemplary embodiment, portion 202 is coupled to a pair of adjacent compressor rotor wheels 130 via mechanical fastening devices 203 including, but not limited to, nuts and bolts. Moreover, bridge portion 202 fully and continuously circumscribes rotor 110. In the exemplary embodiment, bridge portion 202 includes a first hook device 204.

Also, in the exemplary embodiment, interstage seal mechanism 200 includes a ring portion 206 that at least partially circumscribes bridge portion 202, and more specifically, circumscribes bridge portion 202 in a continuous 360°. Ring portion 206 includes a second hook device 208 that is rotatably coupled to first hook device 204. Further, in the exemplary embodiment, bridge portion 202 includes an axial section 210 that is rotatably coupled to a pair of adjacent compressor rotor wheels 130 via mechanical fastening devices 203 such that wheels 130 at least partially support bridge portion 202 via axial section 210.

In the exemplary embodiment, bridge portion 202 and ring portion 206 are each fully integrated components that are formed using any fabrication process that enables operation of interstage seal mechanism 200 as described herein including, but not limited to, a forging process. Alternatively, either bridge portion 202 and/or ring portion 206 are fabricated from a plurality of pieces, components, and/or sections using any fabrication process that enables operation of interstage seal mechanism 200 as described herein including, but not limited to, a brazing process and/or a coupling process using fasting hardware.

Also, in the exemplary embodiment, interstage seal mechanism 200 is positioned a predetermined radial distance 211 from axial centerline 111. Interstage seal mechanism 200 is positioned relative to axial centerline 111 to facilitate reducing a length (not shown) of stator blade assembly 128, and thereby reducing capital costs of fabricating and assembling turbine engine 100 (shown in FIGS. 1, 2, and 3) and reducing an overall weight of turbine engine 100. As such, costs of shipping are facilitated to be reduced as compared to other known turbine engines. Moreover, reducing the length of stator blade assembly 128 facilitates reducing a surface area profile (not shown) of assembly 128 that is exposed to air flowing through compressor 102, thereby reducing associated mechanical stresses in assembly 128 that over time may lead to creep deformation of assembly 128. Such mechanical stresses include, but are not limited to, the forces induced on the assembly by the impacting air flow as a function of the surface area of assembly 128 and a bending moment that is proportional to such induced forces and the length of assembly 128.

In addition, in the exemplary embodiment, first hook device 204 includes a first radial extension 212 that extends from axial section 210. More specifically, in the exemplary embodiment, first radial extension 212 extends radially outward from axial section 210. First hook device 204 also includes a first axial extension 214 that is coupled to first radial extension 212. Therefore, in the exemplary embodiment, bridge portion 202 is a fully unitary component that includes axial section 210, first radial extension 212, and first axial extension 214. First axial extension 214 extends substantially axially a first distance 216 from first radial extension 212.

Also, in the exemplary embodiment, a first angle θ₁ is defined between first extension 214 and first extension 212. Moreover, first extension 214, first extension 212, and axial section 210 define a first annular opening 218. In the exemplary embodiment, angle θ₁ is approximately 90°. Alternatively, angle θ₁ is any angle that enables operation of interstage seal mechanism 200 as described herein.

Further, in the exemplary embodiment, ring portion 206 includes a seal section 220 that substantially circumscribes bridge portion axial section 210. In the exemplary embodiment, seal section 220 includes a plurality of labyrinth sealing devices 222. Alternatively, seal section 220 may include any sealing device(s) that enable operation of interstage seal mechanism 200 as described herein.

Moreover, in the exemplary embodiment, second hook device 208 includes a second radial extension 224 coupled to seal section 220. Second extension 224 extends radially inward from seal section 220. Second hook device 208 also includes a second axial extension 226 that is coupled to second radial extension 224. Therefore, in the exemplary embodiment, ring portion 206 is a fully unitary component that includes member 234, seal section 220, sealing devices 222, second radial extension 224, and second axial extension 226.

Second axial extension 226 extends substantially axially a second distance 228 from second radial extension 224. In the exemplary embodiment, second distance 228 is approximately equal to first distance 216. Alternatively, first and second distances 216 and 228, respectively, have any dimensional relationship that facilitates operation of interstage seal mechanism 200 as described herein. Second extension 226 and second extension 224 define a second angle θ₂ therebetween. Moreover, second extension 226, second extension 224, and seal section 220 define a second annular opening 230. In the exemplary embodiment, angle θ₂ is approximately 90°. Alternatively, angle θ₂ is any angle that enables operation of interstage seal mechanism 200 as described herein.

Also, in the exemplary embodiment, first annular opening 218 receives at least a portion of second extension 226 therein, and second annular opening 230 receives at least a portion of first extension 214 therein, such that an interference fit, or a friction fit is formed between hook devices 204 and 208.

Further, in the exemplary embodiment, second hook device 208 is a third distance 232 from at least one of adjacent compressor rotor wheels 130, wherein third distance 232 is longer than both the first and second distances 216 and 218, respectively. The combination of third distance 232 being longer than first and second distances 216 and 218, respectively, and the interference fit formed between first and second hook devices 204 and 208, respectively, facilitates assembly and disassembly of rotor 110. More specifically, such an assembly orientation facilitates axial sliding movement, of second hook device 208. The axial sliding movement facilitates reducing the amount of disassembly of compressor 102 for routine inspection of interstage seal mechanism 200 and the immediate vicinity thereof.

In the exemplary embodiment, seal section 220 is coupled to an upstream compressor blade attachment mechanism 134 via a member 234. Alternatively, the orientation of interstage seal mechanism 200 may be reversed and in such an orientation, seal section 220 is coupled to a downstream compressor blade attachment mechanism 134, as long as the orientation of interstage seal mechanism 200 facilitates insertion and removal of second hook device 208 from first annular opening 218 as described herein.

The configuration of using adjacent compressor rotor wheels 130 to support the interstage seal mechanism 200 facilitates reducing the overall weight of seal mechanism 200 and reduces the associated costs of fabricating such components. Moreover, such a configuration facilitates eliminating additional rotor wheels to support sealing devices 222, and thereby facilitates reducing in fabrication costs and shipping weights of rotor 110. Also, in the exemplary embodiment, interstage seal mechanism 200 provides sufficient radial support for additional rotating components embedded within rotor 110.

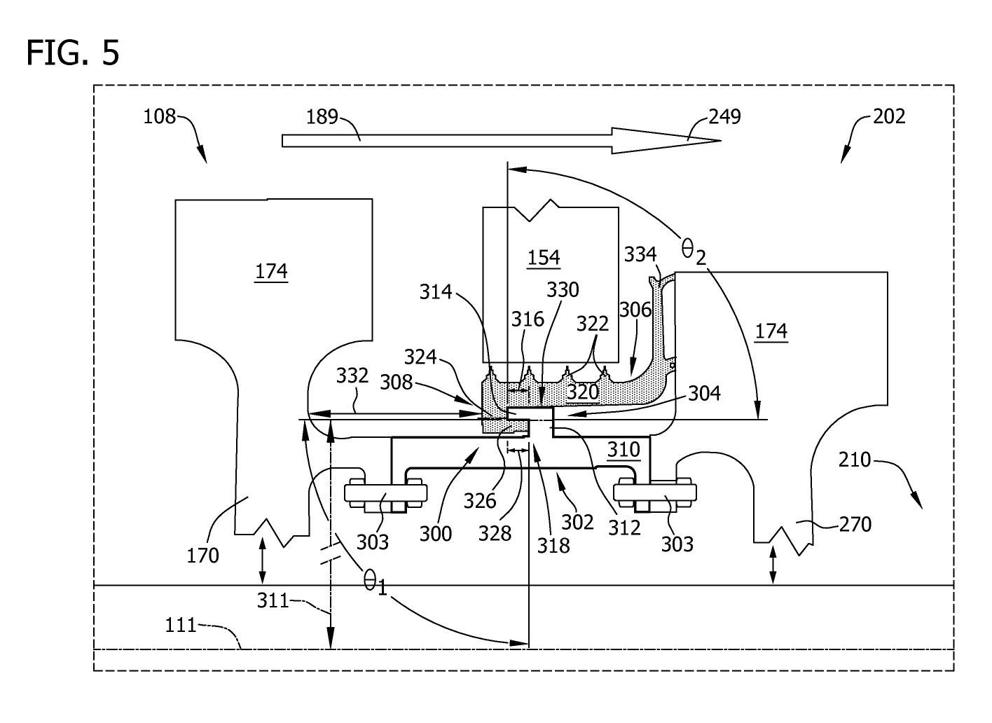

FIG. 5 is an enlarged cross-sectional view of a portion of an exemplary interstage seal mechanism 300 that may be used with turbine 108 taken along area 5 (shown in FIG. 3). In the exemplary embodiment, interstage seal mechanism 300 fully and continuously circumscribes rotor 110. For clarity, bucket assemblies 166 (shown in FIG. 3) are not illustrated in FIG. 5. In the exemplary embodiment, interstage seal mechanism 300 includes a bridge portion 302 that extends substantially axially between a pair of adjacent turbine rotor wheels 170. Bridge portion 302 is rotatably coupled to at least one turbine rotor wheel 170. Specifically, in the exemplary embodiment, portion 302 is rotary coupled to a pair of adjacent turbine rotor wheels 170 via mechanical fastening devices 303 including, but not limited to, nuts and bolts. Moreover, bridge portion 302 fully and continuously circumscribes rotor 110. In the exemplary embodiment, bridge portion 302 includes a first hook device 304.

Also, in the exemplary embodiment, interstage seal mechanism 300 includes a ring portion 306 that at least partially circumscribes bridge portion 302. More specifically, in the exemplary embodiment, ring portion 306 fully and continuously circumscribes bridge portion 302. Ring portion 306 includes a second hook device 308 that is rotatably coupled to first hook device 304. Further, in the exemplary embodiment, bridge portion 302 includes an axial section 310 that is rotatably coupled to adjacent turbine rotor wheels 170 via mechanical fastening devices 303 such that wheels 170 at least partially support bridge portion 302 via axial section 310.

In the exemplary embodiment, bridge portion 302 and ring portion 306 are each fully integrated components that are formed using any fabrication process that enables operation of interstage seal mechanism 300 as described herein including, but not limited to, a forging process. Alternatively, bridge portion 302 and/or ring portion 306 is fabricated from a plurality of pieces, components, and/or sections using any fabrication process that enables operation of interstage seal mechanism 300 as described herein including, but not limited to, a brazing process and/or a coupling process using fastening hardware.

Also, in the exemplary embodiment, interstage seal mechanism 300 is positioned a predetermined radial distance 311 from axial centerline 111. More specifically, interstage seal mechanism 300 is positioned relative to axial centerline 111 to facilitate reducing a radial length (not shown) of turbine diaphragm assembly 154, such that capital costs of fabricating and assembling turbine engine 100 (shown in FIGS. 1, 2, and 3) are facilitated to be reduced as compared to other turbine engines, and such that an overall weight is also reduced. As such, associated costs of shipping are also facilitated to be reduced. Reducing the length of turbine diaphragm assembly 154 facilitates reducing a surface area profile (not shown) of assembly 154 that is exposed to steam or combustion gas flow through turbine 108. As such, associated mechanical stresses in assembly 154 that may lead to creep deformation of assembly 154 over time are also facilitated to be reduced. Such mechanical stresses include, but are not limited to, the forces induced on the assembly by the impacting air flow as a function of the surface area of assembly 154 and a bending moment that is proportional to such induced forces and the length of assembly 154.

Moreover, in the exemplary embodiment, first hook device 304 includes a first radial extension 312 coupled to axial section 310. First extension 312 extends substantially radially outward from axial section 310. First hook device 304 also includes a first axial extension 314 coupled to first extension 312. Therefore, in the exemplary embodiment, bridge portion 302 is a fully unitary component that includes axial section 310, first radial extension 312, and first axial extension 314. First extension 314 extends generally axially a first axial distance 316 from radial extension 312.

First extension 314 and first extension 312 define a first angle θ₁ therebetween. Moreover, first extension 314, first extension 312, and axial section 310 define a first annular opening 318. In the exemplary embodiment, angle θ₁ is approximately 90°. Alternatively, angle θ₁ may be any angle that enables operation of interstage seal mechanism 300 as described herein.

Further, in the exemplary embodiment, ring portion 306 includes a seal section 320 that substantially circumscribes axial section 310 of bridge portion 302. In the exemplary embodiment, seal section 320 may include a plurality of labyrinth sealing devices 322. Alternatively, seal section 320 includes any sealing device that enables operation of interstage seal mechanism 300 as described herein.

Moreover, in the exemplary embodiment, second hook device 308 includes a second radial extension 324 that is coupled to seal section 320. Second extension 324 extends radially inward from seal section 320. Second hook device 308 also includes a second axial extension 326 that is coupled to second extension 324. Therefore, in the exemplary embodiment, ring portion 306 is a fully unitary component that includes member 334, seal section 320, sealing devices 322, second radial extension 324, and second axial extension 326.

Second extension 326 extends generally axially a second distance 328 from second radial extension 324. In the exemplary embodiment, second distance 328 is approximately equal to first distance 316. Alternatively, first and second distances 316 and 328, respectively, have any dimensional relationship that facilitates operation of interstage seal mechanism 300 as described herein. Second extension 326 and second extension 324 define a second angle θ₂ therebetween. Moreover, second extension 326, second extension 324, and seal section 320 define a second annular opening 330. In the exemplary embodiment, angle θ₂ is approximately 90°. Alternatively, angle θ₂ may be any angle that enables operation of interstage seal mechanism 300 as described herein.

Furthermore, in the exemplary embodiment, first annular opening 318 receives at least a portion of second extension 326 therein, and second annular opening 330 receives at least a portion of first extension 314 therein, such that an interference fit, or friction fit is formed between first hook device 304 and second hook device 308.

Further, in the exemplary embodiment, second hook device 308 is a third distance 332 from at least one of the turbine rotor wheels 170. Third distance 332 is longer than both first and second distances 316 and 318, respectively. The combination of third distance 332 being longer than both first and second distances 316 and 318, and the interference fit formed between first and second hook devices 304 and 308, respectively, facilitates assembly and disassembly of rotor 110 by facilitating an axial sliding movement of second hook device 308 without removing any fastening hardware, and/or requiring any new fasting hardware. Further, axial movement facilitates reducing the amount of disassembly of turbine 108 for routine inspection of interstage seal mechanism 300 and the immediate vicinity thereof

In the exemplary embodiment, seal section 320 is coupled to a bucket attachment mechanism 174 via a member 334. Alternatively, the orientation of interstage seal mechanism 300 is reversed and seal section 320 is coupled to a downstream turbine bucket attachment mechanism 174, as the orientation of interstage seal mechanism 300 facilitates insertion and removal of second hook device 308 from first annular opening 318 as described herein.

Using adjacent turbine rotor wheels 170 to support interstage seal mechanism 300 facilitates reducing weights of components of mechanism 300 and associated costs of fabricating such components as compared to other known turbine engines. Moreover, such a configuration facilitates eliminating additional rotor wheels to support sealing devices 322 and reducing and/or eliminating spacers 182, thereby facilitating reducing fabrication costs and shipping weights of rotor 110. Also, in the exemplary embodiment, interstage seal mechanism 300 provides sufficient radial support for additional rotating components embedded within rotor 110, including, but not limited to, cooling air conduits (not shown).

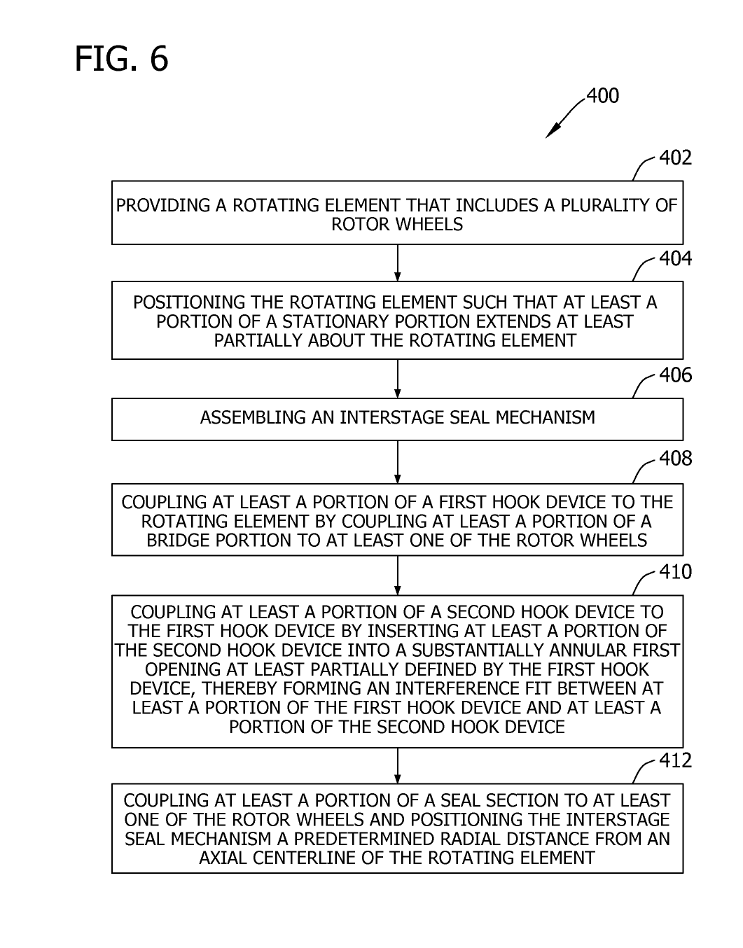

FIG. 6 is a flow chart illustrating an exemplary method 400 of assembling a rotating machine, or more specifically, a portion of gas turbine engine 100 (shown in FIGS. 1, 2, and 3). In the exemplary embodiment, a rotating element, i.e., rotor 110 (shown in FIGS. 1, 2, 3, 4, and 5) that includes a plurality of adjacent compressor rotor wheels 130 (shown in FIGS. 2 and 4) and/or adjacent turbine rotor wheels 170 (shown in FIGS. 3 and 5), is provided 402. Rotor 110 is positioned 404 such that at least a portion of a stationary portion, such as, compressor stator blade assembly 128 (shown in FIGS. 2 and 4) and/or turbine diaphragm assembly 154 (shown in FIGS. 3 and 5) at least partially extends about rotor 110. Interstage seal mechanism 200 for compressor 102 (both shown in FIGS. 2 and 4) and/or interstage seal mechanism 300 for turbine 108 (both shown in FIGS. 3 and 5), are assembled 406. Accordingly, at least a portion of first hook device 204 and/or 304 (shown in FIGS. 4 and 5, respectively) is coupled 408 to rotor 110 by coupling 408 at least a portion of bridge portion 202 and/or 302 (shown in FIGS. 4 and 5, respectively) to at least one rotor wheel 130 and/or 170.

Also, in the exemplary embodiment, at least a portion of second hook device 208 and/or 308 is coupled 410 to first hook device 204 and/or 304, by inserting at least a portion of second hook device 208 and/or 308 into a respective substantially annular first opening 218 and/or 318, at least partially defined by first hook device 204 and/or 304, respectively such that an interference fit is formed between at least a portion of first hook device 204 and/or 304 and at least a portion of second hook device 208 and/or 308, respectively.

Further, in the exemplary embodiment, at least a portion of seal section 220 and/or 320 (shown in FIGS. 4 and 5, respectively) is coupled 412 to at least one of compressor rotor wheel 130 and/or to a turbine rotor wheel 170 by positioning interstage seal mechanism 200 and/or 300 a predetermined radial distance 211 and/or 311, respectively (shown in FIGS. 4 and 5, respectively) from axial centerline 111 (shown in FIGS. 1, 2, 3, 4, and 5). Such method(s) of assembly, and associated methods of disassembly, facilitate reducing assembly and disassembly times and associated costs for routine inspections. More specifically, leveraging the reduced axial lengths necessary for installation and removal of such interstage seal mechanisms facilitate assembling and disassembling both compressor and turbine interstage seal mechanisms.

Described herein are exemplary embodiments of methods and apparatus that facilitate assembling rotating machines, and more specifically, compressors and turbines, including steam turbines and gas turbines. Further, specifically, both compressor and turbine interstage seal mechanisms facilitate assembling and disassembling a compressor and a turbine, respectively, by reducing an axial length necessary for installation and removal of such interstage seal mechanisms. Reducing such assembly/disassembly lengths facilitates reducing disassembly and assembly times and associated costs for routine inspections. Moreover, positioning the interstage seal mechanism sufficiently far enough from a rotor axial centerline facilitates reducing a length of compressor stator blades and turbine diaphragm assemblies, which reduces a surface area of such blades and assemblies exposed to air, steam, or combustion gas flow, and thereby reduces mechanical stresses that may lead to creep deformation over time. Furthermore, such an assembly configuration facilitates reducing and/or eliminating additional rotor discs, including wheels and spacers, to support compressor and turbine sealing devices. Reducing the length of stationary blades and assemblies and elimination of discs facilitates reducing capital costs of fabrication and construction and shipping weights of compressor and turbine rotors. Moreover, the decreased weight of compressors and turbines facilitates decreasing centrifugal forces acting on a common rotor for both compressors and turbines for a range of operational speeds, thereby decreasing the potential for increased inspection and maintenance costs. Further, the decreased weight facilitates a decreased fuel usage to accelerate and maintain a speed of the rotor, thereby decreasing operational costs. Such interstage seal mechanisms also provide sufficient radial support for additional rotating components embedded within the rotor.

The methods and systems described herein are not limited to the specific embodiments described herein. For example, components of each system and/or steps of each method may be used and/or practiced independently and separately from other components and/or steps described herein. In addition, each component and/or step may also be used and/or practiced with other assembly packages and methods.

While the invention has been described in terms of various specific embodiments, those skilled in the art will recognize that the invention can be practiced with modification within the spirit and scope of the claims.

What is claimed is:

1. A method for assembling a rotating machine, said method comprising:
providing a rotating element including a plurality of rotor wheels;
positioning the rotating element such that at least a portion of a stationary portion extends at least partially about the rotating element; and
assembling an interstage seal mechanism comprising:
coupling at least a portion of a first hook device to the rotating element; and
coupling at least a portion of a second hook device to the first hook device, wherein the first hook device and the second hook device are radially inboard of at least a portion of the stationary portion.

2. A method in accordance with claim 1, wherein coupling at least a portion of a second hook device to the first hook device comprises inserting at least a portion of the second hook device into an opening that is at least partially defined by the first hook device.

3. A method in accordance with claim 2, wherein inserting at least a portion of the second hook device into an opening that is at least partially defined by the first hook device comprises forming an interference fit between at least a portion of the first hook device and at least a portion of the second hook device.

4. A method in accordance with claim 1, wherein coupling at least a portion of a first hook device to the rotating element comprises coupling at least a portion of a bridge portion of the interstage seal mechanism to at least one of the plurality of rotor wheels.

5. A method in accordance with claim 4, wherein assembling an interstage seal mechanism further comprises at least one of:
positioning the interstage seal mechanism within a compressor; and
positioning the interstage seal mechanism within a turbine.

6. A method in accordance with claim 1 further comprising coupling at least a portion of a seal of the interstage seal mechanism to at least one of the plurality of rotor wheels.

7. A method in accordance with claim 6, wherein coupling at least a portion of a seal of the interstage seal mechanism to at least one of the plurality of rotor wheels comprises positioning the interstage seal mechanism a predetermined radial distance from an axial centerline of the rotating element.

8. An interstage seal mechanism for a rotating machine having a rotating element and a stationary portion, the rotating element having a plurality of rotor wheels, said interstage seal mechanism comprising:
a bridge portion rotatably coupled to at least one of the rotor wheels, said bridge portion extending axially between the rotor wheels, said bridge portion comprises a first hook device; and
a ring portion at least partially circumscribing said bridge portion, said ring portion comprises a second hook device rotatably coupled to said first hook device.

9. An interstage seal mechanism in accordance with claim 8, wherein said bridge portion further comprises an axial section, said axial section is coupled to at least a portion of at least one of the rotor wheels, the at least one rotor wheel at least partially supports said bridge portion.

10. An interstage seal mechanism in accordance with claim 9, wherein said first hook device comprises:
a first radial extension coupled to said axial section, said first radial extension extending radially outward a predetermined radial distance from said axial section; and
a first axial extension coupled to said first radial extension, said first axial extension extending axially from said first radial extension a first axial distance, said first axial extension and said first radial extension defining a first angle therebetween, said first axial extension, said first radial extension and said axial section defining a first annular opening.

11. An interstage seal mechanism in accordance with claim 10, wherein said ring portion further comprises a seal section, said seal section substantially circumscribes said axial section of said bridge portion.

12. An interstage seal mechanism in accordance with claim 11, wherein said second hook device comprises:
a second radial extension coupled to said seal section, said second radial extension extending radially inward from said seal section; and
a second axial extension coupled to said second radial extension, said second axial extension extending axially from said second radial extension a second axial distance that is substantially similar to said first axial distance, said second axial extension and said second radial extension defining a second angle therebetween, said second axial extension, said second radial extension and said seal section defining a second annular opening.

13. An interstage seal mechanism in accordance with claim 12, wherein said first annular opening receives at least a portion of said second axial extension and said second annular opening receives at least a portion of said first axial extension.

14. An interstage seal mechanism in accordance with claim 12, wherein the first angle is substantially 90° and the second angle is substantially 90°.

15. A turbine engine comprising:
a rotating element comprising a plurality of rotor wheels;
a stationary portion that at least partially extends about said rotating element; and
at least one interstage seal mechanism comprising:
a bridge portion rotatably coupled to at least one of said rotor wheel extensions, said bridge portion extending axially between said rotor wheels, said bridge portion comprises a first hook device; and
a ring portion at least partially circumscribing said bridge portion, said ring portion comprises a second hook device rotatably coupled to said first hook device.

16. A turbine engine in accordance with claim 15, wherein:
said bridge portion further comprises an axial section, said axial section is coupled to at least a portion of at least one of said rotor wheels, said at least one rotor wheel at least partially supports said bridge portion; and
said ring portion further comprises a seal section, said seal section substantially circumscribes said axial section of said bridge portion.

17. A turbine engine in accordance with claim 16, wherein said first hook device comprises:
a first radial extension coupled to said axial section, said first radial extension extending radially outward a predetermined radial distance from said axial section; and
a first axial extension coupled to said first radial extension, said first axial extension extending axially from said first radial extension a first axial distance, said first axial extension and said first radial extension defining a first angle therebetween, said first axial extension, said first radial extension and said axial section defining a first annular opening.

18. A turbine engine in accordance with claim 17, wherein said second hook device comprises:
a second radial extension coupled to said seal section, said second radial extension extending radially inward from said seal section; and
a second axial extension coupled to said second radial extension, said second axial extension extending axially from said second radial extension a second axial distance that is substantially similar to said first axial distance, said second axial extension and said second radial extension defining a second angle therebetween, said second axial extension, said second radial extension and said seal section defining a second annular opening.

19. A turbine engine in accordance with claim 18, wherein said first annular opening receives at least a portion of said second axial extension and said second annular opening receives at least a portion of said first axial extension.

20. A turbine engine in accordance with claim 19, wherein said second hook device is a third axial distance from at least one of said adjacent wheel extensions, said third axial distance is greater than said first and second axial distances.
